(19) United States
(12) Patent Application Publication
(10) Pub. No.: US 2009/0071668 A1
(43) Pub. Date: Mar. 19, 2009

(54) DRAG MAT

(75) Inventor: Charles Edward Hennigar, East New Market, MD (US)

Correspondence Address: BUCHANAN, INGERSOLL & ROONEY PC, POST OFFICE BOX 1404, ALEXANDRIA, VA, 22313-1404, US

(73) Assignee: Cambridge International, Inc., Cambridge, MD (US)

(21) Appl. No.: 12/195,838

(22) Filed: Aug. 21, 2008

Related U.S. Application Data
(60) Provisional application No. 60/935,748, filed on Aug. 29, 2007.

(51) Int. Cl. A01B 31/00

(52) U.S. Cl. 172/612; 172/687

(57) ABSTRACT

A drag mat includes a drag bar attachment, a plurality of connector pins, and a connector rod for securing the drag bar attachment to the mesh of the drag mat. The drag bar attachment eliminates the two-part construction of the prior art and provides reversibility to the drag mat. The plurality of pins and connector rod eliminate the need for a riveted construction and thus simplifies assembly of the drag mat.

### CROSS-REFERENCE TO RELATED APPLICATION

This application relies upon and claims the benefit of priority under 35 U.S.C. 119(e) from U.S. Provisional Application Ser. No. 60/935,748, filed on Aug. 29, 2007.

### FIELD OF THE INVENTION

The present invention is directed to a drag mat, and more particularly to a reversible drag mat that is easily and reliably assembled for use.

### BACKGROUND OF THE INVENTION

Drag mats are generally used for pulverizing hard dirt clumps and leveling athletic fields prior to play, grooming golf courses, and preparing plant beds for seeding. Rigid steel drag mats are increasingly popular with groundskeepers for rapid grooming of an infield, such as between innings, but can also be utilized in day to day maintenance. The rigidity of the drag mat helps to cut down high spots and fill low spots. Drag mats can be pulled by hand, tractor, ATV or specialized grooming machines, as shown in FIG. 1.

Referring to FIGS. 1-3, conventional drag mats 10 are manufactured using ⅜″×0.046″ metal strip and 13 gauge rods to form a mesh pattern. These mats also have a two piece drag bar attachment 12 including a 1×1″ angle iron 14 and 1″ flat bar 16. The pull attachment is generally a polypropylene rope 18 and chain 20. The drag mat 10 is sandwiched between the angle iron 14 and the flat bar 16 and then the angle iron and flat bar are held in place with rivets 22. The angle iron and flat bar are attached to the edge of the mat, making it difficult to hold the mat and bar in place while simultaneously riveting the mat. The rope 18 is attached to the chain 20 and the chain links 20 pass through a slot in the angle iron 14 where they are secured by a rivet 24.

The above-described conventional attachment means 12 applies to rigid drag mats as well as flexible drag mats, as those terms are used in the art to refer to drag mats of different stiffnesses. In both instances, the mats receive a smashed edge treatment and thus have a tendency to snag. Moreover, the two-part attachment means 12 comprising the angle iron and the flat bar limits the use of the drag mat to only one side, i.e., there is a defined top surface and bottom surface, and the mat must be properly oriented for proper use.

Accordingly, there exists a need in the marketplace for a drag mat having an improved means for connecting the pull attachment. It is also desirable to more easily assembly the drag mat, without the difficulty of riveting and holding the drag mat for proper alignment. Further, it is desirable to have a drag mat with no predefined to surface and bottom surface such that the drag mat is, in essence, reversible; thus making the attachment and user thereof more convenient for the user.

### SUMMARY OF THE INVENTION

These and other objects are met by a drag mat comprising a drag bar attachment means, a plurality of connector pins, and a connector rod for securing the drag bar attachment means to the mesh of the drag mat. The drag bar attachment means eliminates the two-part construction of the prior art and provides reversibility to the drag mat.

A further aspect of the invention provides rope connectors which extend through the drag bar attachment means and are secured by the connector rod. The rope connectors preferably include a first hole for receiving the connector rod and a second hole for extending a rope or other tow attachment therethrough.

Another aspect of the invention provides a drag mat including a plurality of connecting rods having a first threaded end that passes through the mesh and the drag bar attachment means, and which are then fastened on that end by a lock nut and flat washer so as to secure the drag mat to the drag bar attachment means.

Still further, the drag mat according to a further aspect of the invention includes a threaded connector, which extends through an opening in the drag bar attachment means for securing thereto a rope, chain, or similar pull attachment. The threaded connector is opened to be disposed through the opening and attached to the rope, and then the threaded connector is screwed to a closed position to secure the same to the drag bar attachment means and thereby attach the pull rope.

### BRIEF DESCRIPTION OF THE DRAWING FIGURES

These and other objects, features, and advantages of the present invention will become more readily apparent to those skilled in the art upon reading the following detailed description, in conjunction with the appended drawings in which:

FIG. 1 is a perspective view of a conventional drag mat being pulled by a tow vehicle.

FIG. 2 is an enlarged perspective view of the detail A shown in FIG. 1.

FIG. 3 is an enlarged exploded view thereof.

FIG. 4 is perspective view of a drag mat according to a first preferred embodiment of the present invention.

FIG. 5 is an enlarged perspective view of the detail A shown in FIG. 4.

FIG. 6 is an enlarged exploded view thereof.

FIG. 7 is an enlarged exploded view of the detail B shown in FIG. 6.

FIG. 8 is an enlarged perspective view of a portion of the drag mat shown in FIG. 4.

FIG. 9 is an enlarged perspective view of a rope attachment connector.

FIG. 10 is a side elevational view thereof.

FIG. 11 is top plan view thereof.

FIG. 12 is an enlarged perspective view of a mesh connector.

FIG. 13 is a side elevational view thereof.

FIG. 14 is top plan view thereof.

FIG. 15 is perspective view of a drag mat according to a second preferred embodiment of the present invention.

FIG. 16 is an enlarged perspective view of the detail A shown in FIG. 15.

FIG. 17 is an exploded view of the drag mat shown in FIG. 15.

FIG. 18 is an enlarged perspective view of the portion of the drag mat shown in FIG. 16.

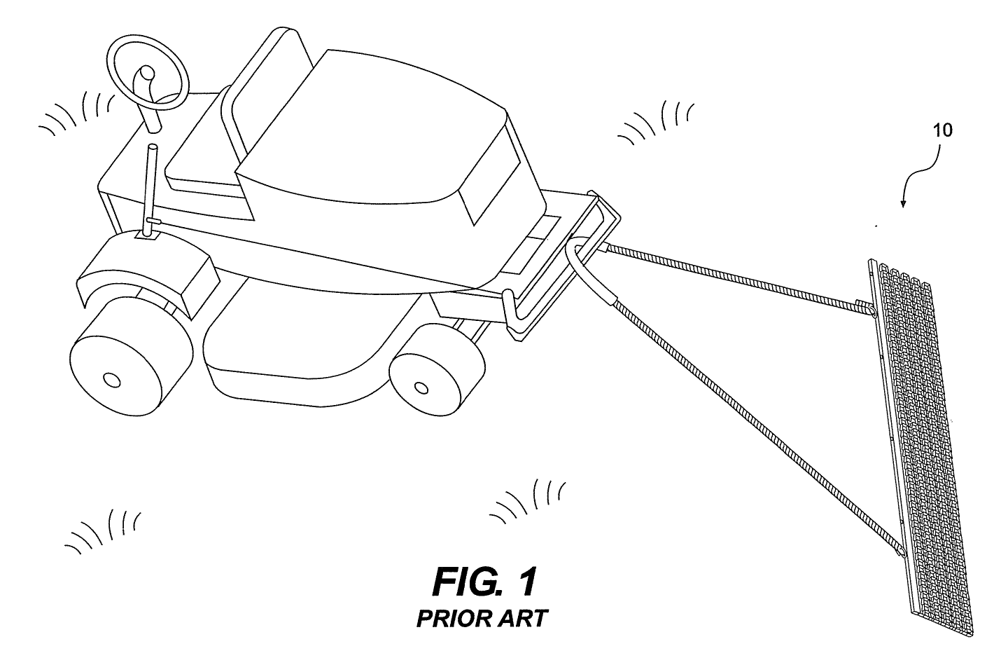

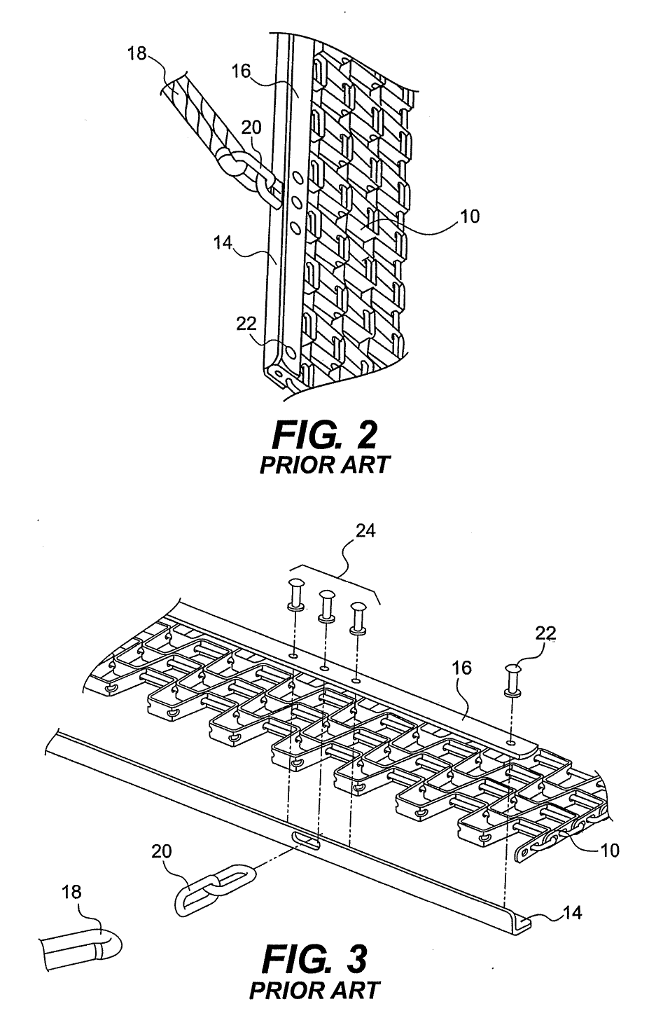

### DETAILED DESCRIPTION OF THE PREFERRED EMBODIMENTS

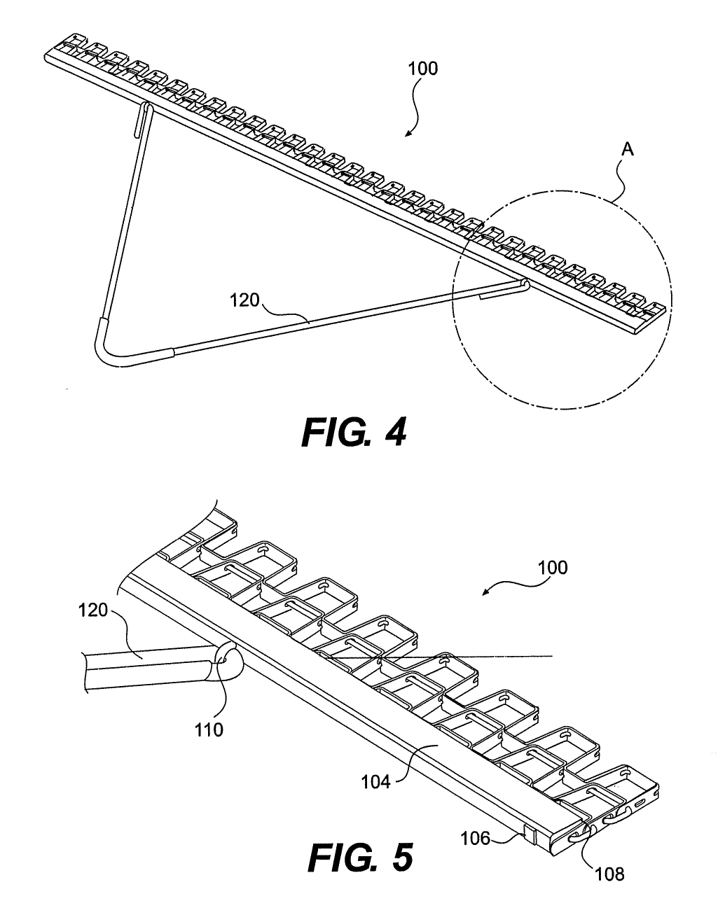

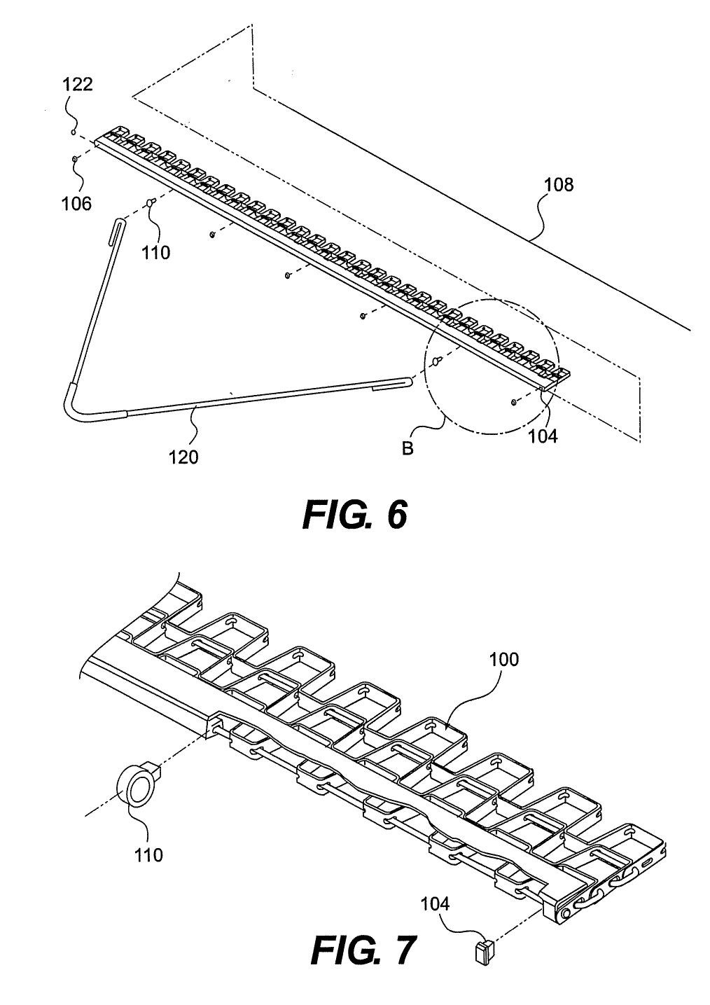

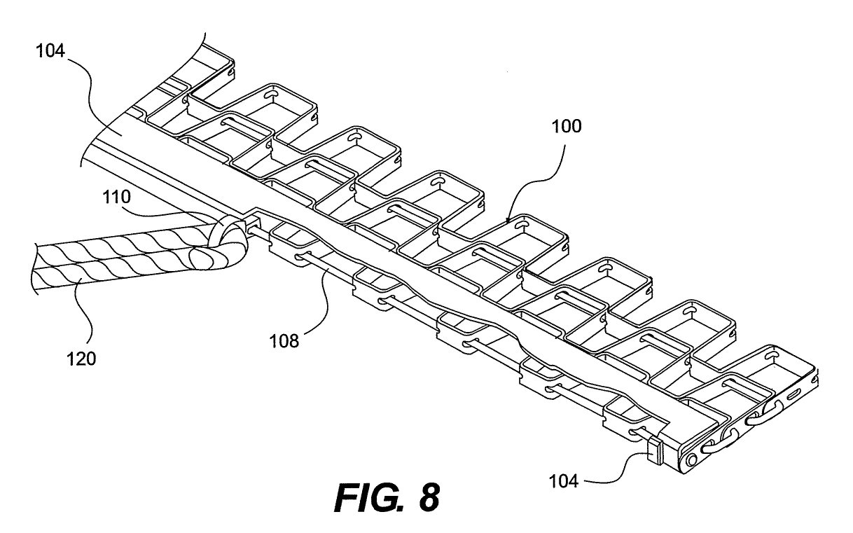

A drag mat according a first preferred embodiment of the present invention is shown generally by reference numeral 100 in FIGS. 4-8, and is considered a rigid drag mat by one skilled in the art due to the longitudinal axis of the mesh being in the direction of travel of the mat. Drag mat 100 is preferably a mesh manufactured using a ⅜″×0.050″ strip and 11 gauge rods, thus creating a stronger mat. The increase in size also increases the weight of the mesh from 1.6 lbs/ft², as found in the convention drag mat 10, to 1.89 lbs/ft², thereby producing a superior drag by breaking clumped soil and spreading cores more effectively. Drag mat 100 also features a clinched edge treatment that protects against snagging and premature failure.

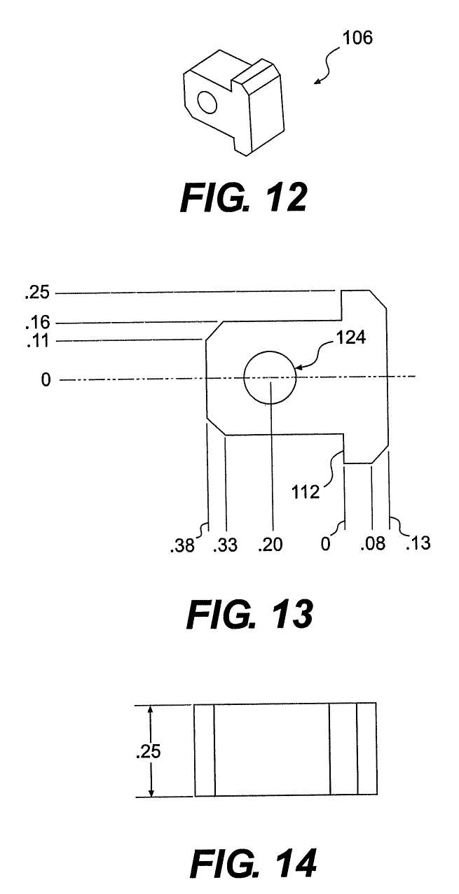

Drag mat 100 includes a one piece drag bar attachment means preferably comprising a U-binding 104 that eliminates the need for rivets and provides a truly reversible drag mat. Rather than using rivets, drag mat 100 includes a plurality of connector pins 106 (see FIGS. 12-14) that are inserted though the U-binding 104 and held in position by a connector rod 108. The U-binding 104 is secured in position by interference from the shoulders 112 on the connector pins 106 and the mesh of mat 100. The connector rod 108 passes through the mat 100 and the connector pins 106, which thereby provides a positive attachment between the drag bar attachment 102 and the mat 100. The connector rod 108 is secured at a terminal end by a locknut 122.

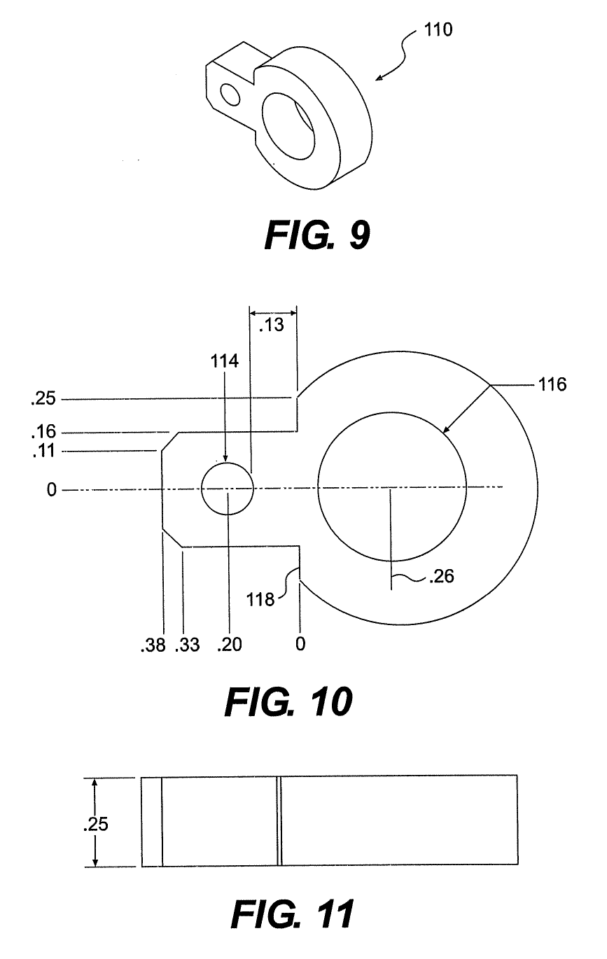

In a preferred embodiment, drag mat 100 also includes a rope connector 110, which extends through the U-binding 104 and secured by connector rod 108. As shown in FIGS. 9-11 rope connector 110 includes a first hole 114 for receiving the connector rod 108 and a second hole 116 for extending a rope or other tow mechanism therethrough. The rope connectors 110 also include a shoulder 118 which abuts the U-binding 104. Accordingly, as one skilled in the alt will appreciate, inserting a connector rod 108 through a plurality of connector pins 106 and rope connectors 110 is considerably easier than the riveting done heretofore. FIGS. 12-14 illustrate in greater detail the connector pin 106 which includes a hole 124 for receiving the connector rod 108 therethrough.

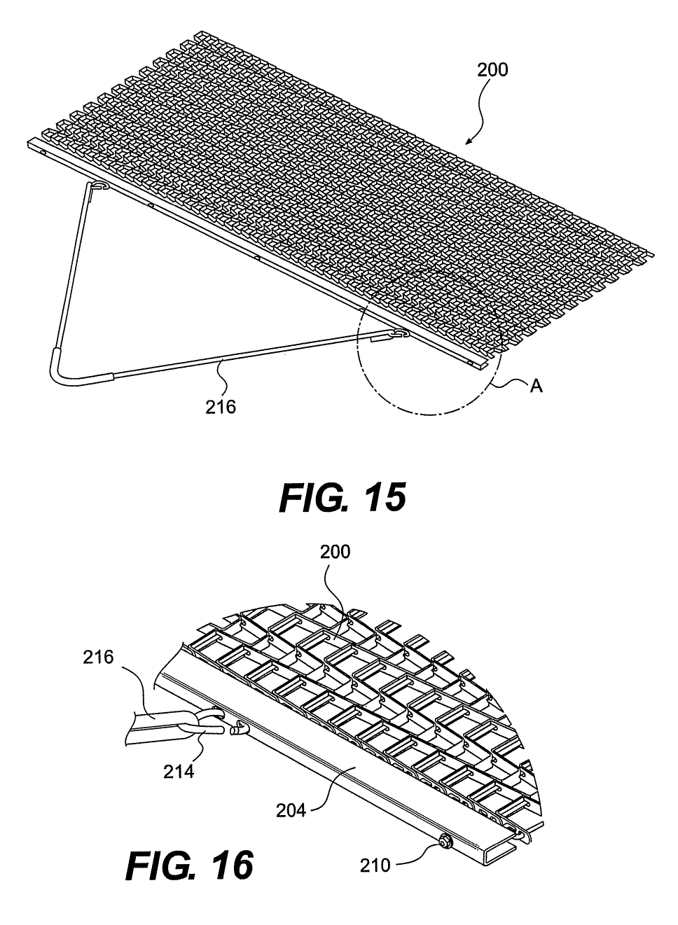

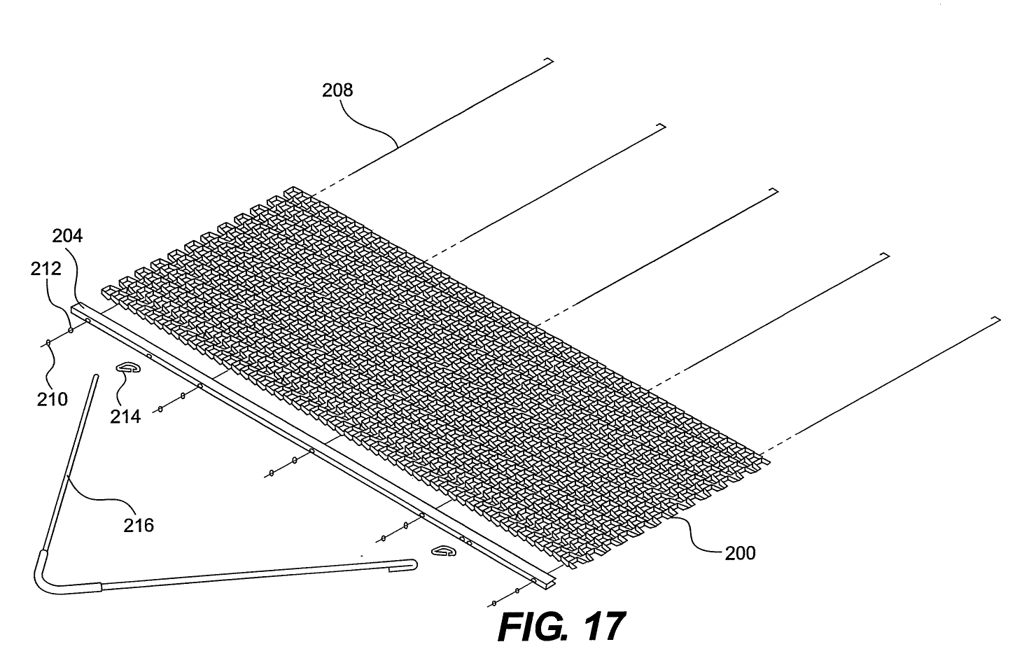

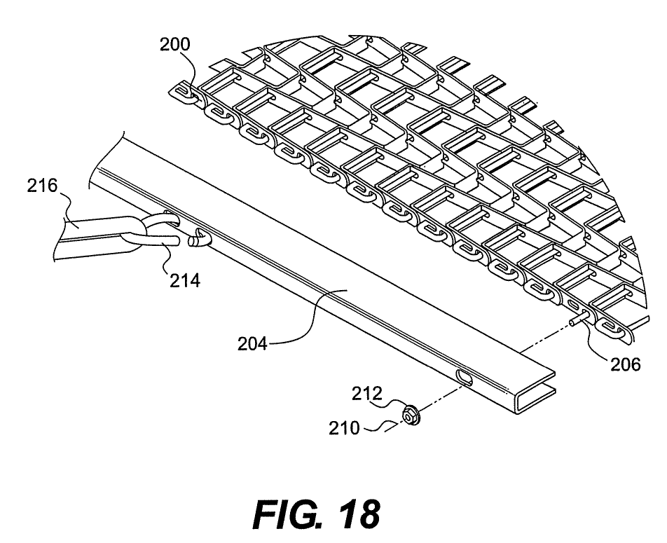

A drag mat according a second preferred embodiment of the present invention is shown generally by reference numeral 200 in FIGS. 15-18, and is considered a flexible drag mat by one skilled in the art due to the longitudinal axis of the mesh being perpendicular to the direction of travel of the mat. Drag mat 200 is preferably a mesh manufactured using a ⅜″×0.050″ strip and 11 gauge rods, thus creating a stronger mat. The increase in size also increases the weight of the mesh from 1.6 lbs/ft², as found in the convention drag mat 10, to 1.89 lbs/ft², thereby producing a superior drag by breaking clumped soil and spreading cores more effectively. Drag mat 200 also features a clinched edge treatment that protects against snagging and premature failure.

Drag mat 200 includes a one piece drag bar attachment means preferably comprising a U-binding 204 that eliminates the need for rivets and provides a truly reversible drag mat. Rather than using rivets, drag mat 200 includes a plurality of connecting rods 208 having a first threaded end 206 that passes though the mesh and the U-binding 204 and are then fastened on that end by a lock nut 210 and flat washer 212. The opposing end of the connecting rod 208 is hooked and, after insertion, is clinched to the mat 200 in the same fashion as the other rods in the mat. Thus, a positive attachment is obtained between the drag bar attachment means 204 and the mat 200.

In a preferred embodiment, drag mat 200 also includes a threaded connector 214, which extends through an opening 218 in the U-binding 204 for securing thereto a rope 216, chain (not shown), or similar pull attachment. The threaded connector 214 is opened to be disposed through the opening 218 and attached to the rope 216, and then connector 214 is screwed to a closed position to secure the same to the U-binding and thereby attach the rope 216.

Although certain preferred embodiments of the present invention have been shown and described in detail, it should be understood that various changes and modifications may be made therein without departing from the scope of the appended claims.

I claim:

1. A drag mat comprising:
a body member including a mesh mat;
a drag bar attachment means;
a plurality of connector pins inserted through said drag bar attachment means for securing said drag bar attachment means to said body member, said connector pins including a transverse opening; and
a connector rod extending through said transverse openings of said connector pins, thereby securing said plurality of connector pins within said drag bar attachment means.

2. The drag mat according to claim 1, wherein said drag bar attachment means comprises a U-shaped binding.

3. The drag mat according to claim 1, wherein said plurality of connector pins include shoulder portions, the drag bar attachment means being secured in position by interference from said shoulders on said connector pins and the mesh mat of said body member.

4. The drag mat according to claim 1, wherein said connector rod passes through the mesh mat of said body member and said plurality of connector pins, thereby providing a positive attachment between the drag bar attachment means and the mesh mat.

5. The drag mat according to claim 1, wherein said connector rod is secured at a terminal end by a locknut.

6. The drag mat according to claim 1, further comprising at least one rope connector extending through said drag bar attachment means and secured by said connector rod.

7. The drag mat according to claim 6, wherein said rope connector includes a first hole for receiving said connector rod and a second hole for extending a tow mechanism therethrough.

8. The drag mat according to claim 7, wherein said tow mechanism comprises a rope.

9. The drag mat according to claim 7, wherein said at least one rope connector further includes a shoulder portion which abuts said drag bar attachment means.

10. The drag mat according to claim 1, wherein said body member defines a rigid drag mat.

11. The drag mat according to claim 1, wherein said drag mat is reversible.

12. A drag mat comprising:
a body member including a mesh mat;
a drag bar attachment means;
a plurality of connecting rods having a threaded end that passes through said mesh mat and said drag bar attachment means and an opposing hooked end that is clinched to said mesh mat;
securing means for fastening said connecting rods through said drag bar attachment means, thereby obtaining a positive attachment between said drag bar attachment means and said mesh mat.

13. The drag mat according to claim 12, further comprising a threaded connector extending through an opening in said drag bar attachment means for securing a pull attachment thereto.

14. The drag mat according to claim 13, wherein said threaded connector is opened to be disposed through the opening in said drag bar attachment means and attached to the pull attachment, and screwed to a closed position to secure the same to said drag bar attachment means and thereby attach the pull attachment.

15. The drag mat according to claim 14, wherein the pull attachment comprises a rope.

16. The drag mat according to claim 12, wherein said drag bar attachment means comprises a U-shaped binding.

17. The drag mat according to claim 12, wherein said securing means for fastening said connecting rods through said drag bar attachment means includes a lock nut secured to the threaded end of said connecting rod.

18. The drag mat according to claim 12, wherein said body member defines a flexible drag mat.

19. The drag mat according to claim 12, wherein said drag mat is reversible.
